(19) United States
(12) Patent Application Publication
(10) Pub. No.: US 2025/0246668 A1
(43) Pub. Date: Jul. 31, 2025

(54) MULTILAYERED ELECTROCHEMICAL CELLS, AND METHODS OF PRODUCING THE SAME

(71) Applicant: 24M Technologies, Inc., Cambridge, MA (US)

(72) Inventors: Junhua SONG, Sudbury, MA (US); Dhanya PUTHUSSERI, Millis, MA (US); Grace O'DWYER, Brighton, MA (US); Michelle Robyn BROUWER, Woburn, MA (US); Frank Yongzhen FAN, Arlington, MA (US); Junzheng CHEN, Concord, MA (US)

(21) Appl. No.: 19/040,104

(22) Filed: Jan. 29, 2025

Related U.S. Application Data
(60) Provisional application No. 63/627,344, filed on Jan. 31, 2024.

(51) Int. Cl. H01M 10/04; H01M 50/105

(52) U.S. Cl. CPC H01M 10/0454; H01M 10/0459; H01M 10/0468; H01M 50/105

(57) ABSTRACT

In some aspects, an electrochemical apparatus can include an anode current collector, a first anode material disposed on a first side of the anode current collector, and a second anode material disposed on a second side of the anode current collector, the second side opposite the first side. The apparatus further includes a cathode current collector with a first cathode material disposed on a first section of the cathode current collector and a second cathode material disposed on a second section of the cathode current collector. The apparatus further includes a separator folded such that a first portion of the separator is interposed between the first anode material and the first cathode material and a second portion of the separator is interposed between the second anode material and the second cathode material.

### CROSS-REFERENCE TO RELATED APPLICATIONS

This application claims priority to and the benefit of U.S. Provisional Application No. 63/627,344, filed Jan. 31, 2024, and entitled “Multilayered Electrochemical Cells, and Methods of Producing the same,” the entire disclosure of which is hereby incorporated by reference herein.

### TECHNICAL FIELD

Embodiments described herein relate to electrochemical cells with multiple active layers.

### BACKGROUND

The energy density of an electrochemical cell is related to the ratio of active to inactive materials in the electrochemical cell. Inactive materials can include current collectors, separators, packaging (e.g., pouches), tabs, tape electrolyte, and/or binder. The energy density of an electrochemical cells can be improved by reducing the proportional amount of inactive material in the electrochemical cell.

### SUMMARY

Embodiments described herein relate to multilayered electrochemical cells. In some aspects, an electrochemical apparatus can include an anode current collector, a first anode material disposed on a first side of the anode current collector, and a second anode material disposed on a second side of the anode current collector, the second side opposite the first side. The apparatus further includes a cathode current collector with a first cathode material disposed on a first section of the cathode current collector and a second cathode material disposed on a second section of the cathode current collector. The apparatus further includes a separator folded such that a first portion of the separator is interposed between the first anode material and the first cathode material and a second portion of the separator is interposed between the second anode material and the second cathode material.

In some aspects, an electrochemical apparatus can include a cathode current collector, a first cathode material disposed on a first side of the cathode current collector, and a second cathode material disposed on a second side of the cathode current collector, the second side opposite the first side. The apparatus further includes an anode current collector with a first anode material disposed on a first section of the anode current collector and a second anode material disposed on a second section of the anode current collector. The apparatus further includes a separator folded such that a first portion of the separator is interposed between the first cathode material and the first anode material and a second portion of the separator is interposed between the second cathode material and the second anode material.

In some aspects, a method of forming an electrochemical apparatus can include disposing a first anode material onto a first side of an anode current collector and disposing a second anode material onto second side of anode current collector. The method further includes disposing a first cathode material onto a first section of a cathode current collector and disposing a second cathode material onto a second section of the cathode current collector. In some embodiments, the method may include disposing a separator onto one of the first cathode material and the second cathode material, or the first anode material and the second anode material, such that the separator has a folded configuration; and disposing the cathode current collector around the anode current collector by folding the cathode current collector.

In some embodiments, an apparatus includes: a first anode current collector having a first side and a second side opposite the first side; a first anode material disposed on the first side of the first anode current collector; a second anode current collector having a first side and a second side opposite the first side; a second anode material disposed on the second side of the second anode current collector; a cathode current collector; a first cathode material disposed on a first section of the cathode current collector; a second cathode material disposed on a second section of the cathode current collector; and a separator folded such that a first portion of the separator is interposed between the first anode material and the first cathode material and a second portion of the separator is interposed between the second anode material and the second cathode material, the second side of the first anode current collector being electrically coupled to the first side of the second anode current collector.

In some embodiments, an apparatus includes: an anode current collector; a separator folded such that a first portion of the separator is on a first side of the anode current collector and a second portion of the separator is on a second side of the anode current collector; a first anode material disposed on the first portion of the separator and adjacent to the anode current collector; a second anode material disposed on the second portion of the separator and adjacent to the anode current collector; a cathode current collector; a first cathode material disposed on the first portion of the separator and adjacent to a first section of the cathode current collector; and a second cathode material disposed on the second portion of the separator and adjacent to a second section of the cathode current collector.

### BRIEF DESCRIPTION OF THE DRAWINGS

FIG. 1 is a block diagram of an electrochemical apparatus, according to an embodiment.

FIG. 2 is an illustration of an electrochemical apparatus, according to an embodiment.

FIG. 3 is an illustration of a current collector configuration, according to an embodiment.

FIG. 4 is an illustration of a current collector configuration, according to an embodiment.

FIG. 5 is an illustration of a current collector configuration, according to an embodiment.

FIG. 6 is a flow diagram of a method of forming an electrochemical apparatus, according to an embodiment.

FIG. 7 is a flow diagram of a method of forming an electrochemical apparatus, according to an embodiment.

FIG. 8 shows plots of voltage vs capacity of an electrochemical apparatus compared with the voltage vs capacity plot of comparative non-folded electrochemical apparatus, at a charging C-rate of C/5 and a discharging C-rate of C/3.

FIG. 9 shows a plot of voltage vs capacity of an electrochemical apparatus using conventional electrode, at a charging C-rate of C/20 and a discharging C-rate of C/10.

FIGS. 10A-10B are illustrations of an electrochemical apparatus, according to an embodiment.

FIG. 11 is a plot of potential vs. charge capacity/discharge capacity of an example electrochemical cell including a folded separator and cathode current collector, according to an embodiment.

### DETAILED DESCRIPTION

Electrochemical cells made using existing unit cell design have reduced energy densities due to the presence of several layers of inactive material. Specifically, unit cells often include two layers of pouch film (e.g., polyethylene terephthalate carrier film), one layer for each of the anode and cathode current collector. Unit cells also include a separator. In such cases, each current collector is coated on only one side with electrode material. This increases the proportional amount of current collector material in the system. Layers of inactive material do not contribute to the capacity of the system.

Additionally, large-area lithium metal batteries with commercially competitive capacities present a challenge for sourcing wide format (i.e., >120 mm) lithium metal foil, particularly if the lithium foil is thin (an important characteristic for high density applications). Therefore, it is desirable to develop high-capacity electrochemical cells and apparatuses with relatively narrow form factors.

By coating either an anode current collector or a cathode current collector on both sides, the proportional amount of inactive current collector material is reduced by half on either the anode side or the cathode side of the electrochemical cell. Double sided electrochemical cells are described in U.S. Pat. No. 11,742,525, filed Feb. 8, 2021, and titled, “Divided Energy Electrochemical Cells Systems and Methods of Producing the Same,” the entire disclosure of which is hereby incorporated by reference.

With one of the current collectors enveloped in the other of the current collectors, only one of the anode current collector or the cathode current collector is coupled or laminated to a carrier film. This reduces the amount of carrier film used in a system, compared to a baseline unit cell design. In some implementations, an anode current collector foil approximately half the size of a standard unit cell can be laminated on both sides with lithium metal foil, and the cathode (having the full standard unit cell size) is folded around the anode. This reduces by half the width of lithium foil used in the electrochemical cell. Alternatively, the central electrode can include a single half-sized cathode or anode current collector, coated on both sides with active material via a semi-sold electrode material. In some embodiments, the central electrode can include a full-sized anode or cathode current collector, coated on one side and folded in half, such that the active material is facing outward. By reducing the footprint of a unit cell while maintaining the same capacity, more flexibility in design is possible. Some embodiments described herein can include any tabbing form factors.

Other examples of stacked electrodes can be found in U.S. Pat. No. 10,637,038, filed Nov. 4, 2015, and titled, “Electrochemical Cells Having Semi-Solid Electrodes and Methods of Manufacturing the Same,” the entire disclosure of which is hereby incorporated by reference.

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes.

In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can include a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid electrodes are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosure of which is hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “conventional separator” means an ion permeable membrane, material, medium, film, or layer that provides electrical isolation between an anode and a cathode, while allowing charge-carrying ions to pass therethrough. Conventional separators do not provide chemical and/or fluidic isolation of the anode and cathode.

As used herein, the term “semi-solid” refers to a material that is a mixture of liquid and solid phases, for example, such as a particle suspension, a slurry, a colloidal suspension, an emulsion, a gel, or a micelle.

As used herein, the terms “energy density” and “volumetric energy density” refer to the amount of energy (e.g., MJ) stored in an electrochemical cell per unit volume (e.g., L), including the electrodes, the separator, the electrolyte, the current collectors, and cell packaging. Unless otherwise noted, energy density and volumetric density include cell packaging.

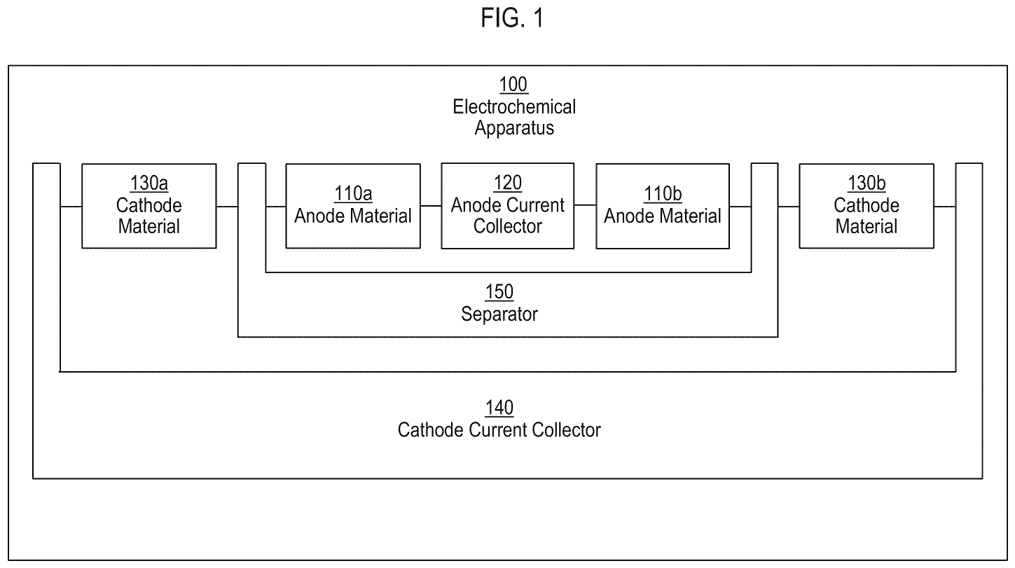

FIG. 1 shows a block diagram of an electrochemical apparatus 100, according to an embodiment. The electrochemical apparatus 100 includes an anode current collector 120, a first anode material 110a disposed on a first side of the anode current collector 120 and a second anode material 110b disposed on a second side of the anode current collector 120, the second side being opposite to the first side. The electrochemical apparatus 100 further includes a cathode current collector 140, a first cathode material 130a disposed on a first section of the cathode current collector 140 and a second cathode material 130b disposed on a second section of the cathode current collector 140. The electrochemical apparatus 100 further includes a separator 150 folded along a fold line such that a first portion of the separator 150 is interposed between the first anode material 110a and the first cathode material 130a and a second portion of the separator is interposed between the second anode material 110b and the second cathode material 130b.

In some embodiments, the cathode current collector 140 can be folded around the anode current collector 120. For example, in some embodiments, the cathode current collector 140 can be folded along a fold line such that the anode current collector 120 and the separator 150 are substantially contained within the cathode current collector 140. This configuration can allow for a reduced size of the anode current collector 120 compared to that of an electrochemical cell without a folded configuration. For example, in some embodiments, the size of the anode current collector 120 may be approximately half that of the cathode current collector 140.

In some embodiments, the cathode current collector 140 can have a first surface and a second surface opposite to the first surface, the first surface facing the anode current collector 120 when the cathode current collector 140 is folded along the fold line. In some embodiments, the second surface of the cathode current collector 140 can be coated with a heat-sealing coating (e.g., a heat-sealable adhesive).

In some embodiments, the cathode current collector 140 has a width dimension and a length dimension longer than the width dimension, and the fold line extends along the length dimension. In some embodiments, the cathode current collector 140 has a width dimension and a length dimension longer than the width dimension, and the fold line extends along the width dimension.

In some embodiments, the electrochemical apparatus 100 can be a high power density cell. In some embodiments, the electrochemical apparatus 100 can be a high energy density cell. In some embodiments, the electrochemical apparatus 100 can have high capacity retention.

In some embodiments, “high power density cell” can refer to an electrochemical cell with a cell specific power output of at least about 400 W/kg, at least about 450 W/kg, at least about 500 W/kg, at least about 550 W/kg, at least about 600 W/kg, or at least about 650 W/kg, or at least about 700 W/kg, inclusive of all values and ranges therebetween.

In some embodiments, “high energy density cell” can refer to an electrochemical cell with a cell specific energy density of at least about 250 W·h/kg when discharged at 1C, at least about 300 W·h/kg when discharged at 1C, at least about 350 W·h/kg when discharged at 1C, at least about 400 W·h/kg when discharged at 1C, or at least about 450 W·h/kg when discharged at 1C, inclusive of all values and ranges therebetween In some embodiments, “high energy density cell” can refer to an electrochemical cell with a specific energy density of at least about 250 W·h/kg when discharged at C/2, at least about 300 W·h/kg when discharged at C/2, at least about 350 W·h/kg when discharged at C/2, at least about 400 W·h/kg when discharged at C/2, or at least about 450 W·h/kg when discharged at C/2, inclusive of all values and ranges therebetween In some embodiments, “high energy density cell” can refer to an electrochemical cell with a specific energy density of at least about 250 W·h/kg when discharged at C/4, at least about 300 W·h/kg when discharged at C/4, at least about 350 W·h/kg when discharged at C/4, at least about 400 W·h/kg when discharged at C/4, or at least about 450 W·h/kg when discharged at C/4, inclusive of all values and ranges therebetween.

In some embodiments, “high capacity retention” can refer to an electrochemical cell that retains at least about 80%, at least about 85%, at least about 90%, at least about 95%, at least about 96%, at least about 97%, at least about 98%, or at least about 99% of its initial discharge capacity after 1,000 cycles, inclusive of all values and ranges therebetween.

In some embodiments, the electrochemical apparatus 100 can have a thickness of at least about 100 μm, at least about 150 μm, at least about 200 μm, at least about 250 μm, at least about 300 μm, at least about 350 μm, at least about 400 μm, at least about 450 μm, at least about 500 μm, at least about 550 μm, at least about 600 μm, at least about 650 μm, at least about 700 μm, at least about 750 μm, at least about 800 μm, at least about 850 μm, at least about 900 μm, or at least about 950 μm. In some embodiments, the electrochemical apparatus 100 can have a thickness of no more than about 1,000 μm, no more than about 950 μm, no more than about 900 μm, no more than about 850 μm, no more than about 800 μm, no more than about 750 μm, no more than about 700 μm, no more than about 650 μm, no more than about 600 μm, no more than about 550 μm, no more than about 500 μm, no more than about 450 μm, no more than about 400 μm, no more than about 350 μm, no more than about 300 μm, no more than about 250 μm, no more than about 200 μm, or no more than about 150 μm. Combinations of the above-referenced thicknesses of the electrochemical apparatus 100 are also possible (e.g., at least about 100 μm and no more than about 1,000 μm or at least about 200 μm and no more than about 500 μm), inclusive of all values and ranges therebetween. In some embodiments, the electrochemical apparatus 100 can have a thickness of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, or about 1,000 μm.

In some embodiments, at least one of the first anode material 110a or the second anode material 110b can be a semi-solid electrode. In some embodiments, at least one of the first cathode material 130a or the second cathode material 130b can be a semi-solid electrode.

In some embodiments, the electrode materials described herein can include a flowable semi-solid or condensed liquid composition. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in a liquid electrolyte to produce a semi-solid electrode. Examples of electrochemical cells that include a semi-solid and/or binderless electrode material are described in U.S. Pat. No. 8,993,159 entitled, “Semi-solid Electrodes Having High Rate Capability,” registered Mar. 31, 2015, the entire disclosure of which is hereby incorporated by reference. In some embodiments, the electrochemical cell can include conventional electrodes (e.g., solid electrodes with binders). That is, the electrochemical cell according to multiple embodiments described herein, may include a binder. The binder can be chosen among commonly used binders (e.g., polymer binders) in the art. For example, the binder can be selected from at least one of polyvinylidene fluoride (PVDF), styrene-butadiene rubber (SBR), carboxymethyl cellulose sodium (CMC), polyvinyl alcohol (PVA), poly(methyl methacrylate) (PMMA), poly(acrylic acid) (PAA), poly(ethylene oxide) (PEO) or elastomer water-soluble binder.

In some embodiments, at least one of the first anode material or the second anode material can be a conventional electrode. In some embodiments, at least one of the first cathode material 130a or the second cathode material 130b can include a conventional electrode. In some embodiments, the thickness of the conventional electrodes can be in the range of about 20 μm to about 100 μm, about 20 μm to about 90 μm, about 20 μm to about 80 μm, about 20 μm to about 70 μm, about 20 μm to about 60 μm, about 25 μm to about 60 μm, about 30 μm to about 60 μm, about 20 μm to about 55 μm, about 25 μm to about 55 μm, about 30 μm to about 55 μm, about 20 μm to about 50 μm, about 25 μm to about 50 μm, or about 30 μm to about 50 μm, inclusive of all values and ranges therebetween. In some embodiments, the thickness of the conventional electrodes can be about 20 μm, about 25 μm, about 30 μm, about 35 μm, about 40 μm, about 45 μm, about 50 μm, about 55 μm, or about 60 μm, inclusive of all values and ranges therebetween.

In some embodiments, the first anode material 110a can have a quantity similar to, or substantially the same as a quantity of the second anode material 110b. In some embodiments, the first anode material 110a can have a chemical composition similar to, or substantially the same as, a chemical composition of the second anode material 110b. In some embodiments, the first anode material 110a can have a thickness similar to, or substantially the same as, a thickness of the second anode material 110b. In some embodiments, the first anode material 110a can be different from the second anode material 110b in quantity, chemical composition, thickness, density, porosity, and/or any other properties.

In some embodiments, the first anode material 110a and/or the second anode material 110b (collectively referred to as “anode materials 110”) can include graphite, lithium metal (Li), sodium metal (Na), silicon oxide (SiO), silicon, carbon, lithium-intercalated carbon, lithium nitrides, lithium alloys, lithium alloy forming compounds, or any other anode active material, inclusive of all combinations thereof. In some embodiments, the lithium alloy forming compounds can include silicon, bismuth, boron, gallium, indium, zinc, tin, antimony, aluminum, titanium oxide, molybdenum, germanium, manganese, niobium, vanadium, tantalum, gold, platinum, iron, copper, chromium, nickel, cobalt, zirconium, yttrium, molybdenum oxide, germanium oxide, silicon carbide, or silicon-graphite composite.

In some embodiments, the first anode material 110a and/or the second anode material 110b can have a thickness of at least about 20 μm, at least about 30 μm, at least about 40 μm, at least about 50 μm, at least about 60 μm, at least about 70 μm, at least about 80 μm, at least about 90 μm, at least about 100 μm, at least about 110 μm, at least about 120 μm, at least about 130 μm, or at least about 140 μm. In some embodiments, the first anode material 110a and/or the second anode material 110b can have a thickness of no more than about 150 μm, no more than about 140 um, no more than about 130 μm, no more than about 120 μm, no more than about 110 μm, no more than about 100 μm, no more than about 90 μm, no more than about 80 μm, no more than about 70 μm, no more than about 60 μm, no more than about 50 μm, or no more than about 30 μm. Combinations of the above-referenced thicknesses of the first anode material 110a and/or the second anode material 110b are also possible (e.g., at least about 20 μm and no more than about 150 μm or at least about 50 μm and no more than about 100 μm), inclusive of all values and ranges therebetween. In some embodiments, the first anode material 110a and/or the second anode material 110b can have a thickness of about 20 μm, about 30 μm, about 40 μm, about 50 μm, about 60 μm, about 70 μm, about 80 μm, about 90 μm, about 100 μm, about 110 μm, about 120 μm, about 130 μm, about 140 μm, or about 150 μm.

In some embodiments, the anode material 110a and/or the anode material 110b can be deposited on the anode current collector 120. In some embodiments, the anode material 110a and/or the anode material 110b can be deposited on the separator 150. In some embodiments, the cathode material 130a and/or the cathode material 130b can be deposited on the cathode current collector 140. In some embodiments, the cathode material 130a and/or the cathode material 130b can be deposited on the separator 150.

In some embodiments, the first anode material 110a can have a thickness greater than the thickness of the second anode material 110b. In some embodiments, the first anode material 110a can be thicker than the second anode material 110b by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, the first cathode material 130a can have a quantity similar to, or substantially the same as, a quantity of the second cathode material 130b. In some embodiments, the first cathode material 130a can have a chemical composition the similar to, or substantially the same as, a chemical composition of the second cathode material 130b. In some embodiments, the first cathode material 130a can have a thickness similar to, or substantially the same as, a thickness of the second cathode material 130b. In some embodiments, the first cathode material 130a can be different from the second cathode material 130b in quantity, chemical composition, thickness, density, porosity, and/or any other properties.

In some embodiments, the first cathode material 130a and/or the second cathode material 130b (collectively referred to as “cathode materials 130”) can include Lithium cobalt oxide (LCO), lithium nickel manganese cobalt oxide (NMC), lithium iron phosphate (LFP), or any other cathode active material, inclusive of all combinations thereof.

In some embodiments, the first cathode material 130a and/or the second cathode material 130b can have a thickness of at least about 50 μm, at least about 60 μm, at least about 70 um, at least about 80 μm, at least about 90 μm, at least about 100 μm, at least about 110 μm, at least about 120 μm, at least about 130 μm, at least about 140 μm, at least about 150 μm, at least about 200 μm, at least about 250 μm, at least about 300 μm, at least about 350 μm, at least about 400 μm, or at least about 450 μm. In some embodiments, the first cathode material 130a and/or the second cathode material 130b can have a thickness of no more than about 500 μm, no more than about 450 μm, no more than about 400 μm, no more than about 350 μm, no more than about 300 μm, no more than about 250 μm, no more than about 200 μm, no more than about 150 μm, no more than about 140 μm, no more than about 130 μm, no more than about 120 μm, no more than about 110 μm, no more than about 100 μm, no more than about 90 μm, no more than about 80 μm, no more than about 70 μm, or no more than about 60 μm. Combinations of the above-referenced thicknesses of the first cathode material 130a and/or the second cathode material 130b are also possible (e.g., at least about 50 μm and no more than about 500 μm or at least about 100 μm and no more than about 300 μm), inclusive of all values and ranges therebetween. In some embodiments, the first cathode material 130a and/or the second cathode material 130b can have a thickness of about 50 μm, about 60 μm, about 70 μm, about 80 μm, about 90 μm, about 100 μm, about 110 μm, about 120 μm, about 130 μm, about 140 μm, about 150 μm, about 200 μm, about 250 μm, about 300 μm, about 350 μm, about 400 μm, about 450 μm, or about 500 μm.

In some embodiments, the first cathode material 130a can have a thickness greater than the thickness of the second cathode material 130b. In some embodiments, the first cathode material 130a can be thicker than the second cathode material 130b by a factor of at least about 1, at least about 1.1, at least about 1.2, at least about 1.3, at least about 1.4, at least about 1.5, at least about 1.6, at least about 1.7, at least about 1.8, at least about 1.9, at least about 2, at least about 2.5, at least about 3, at least about 3.5, at least about 4, at least about 4.5, or at least about 5.

In some embodiments, the separator 150 can be folded along a fold line, such that the anode current collector 120 is substantially contained within the separator 150. Accordingly, in some embodiments, the separator 150 is larger (i.e., having a larger surface area) than the anode current collector 120.

In some embodiments, the separator 150 can further include a coating material disposed on at least a portion of at least one surface of the separator 150. In some embodiments, the coating material may be an insulating material. In some embodiments, the insulating material may be configured to prevent perforation of the separator at the fold area and the resulting electrical contact (i.e., short circuit) between the cathode materials 130 and anode materials 110. In some embodiments, the coating material may be in the form of a tape, a slurry (i.e., a non-conductive slurry), a paste or a film. In some embodiments, the coating material may further have adhesive properties. In some embodiments, the coating material may be disposed on a portion of the separator 150, for example, at and around the fold line.

In some embodiments, the separator 150 can include a selectively permeable material (e.g., a selectively permeable membrane, layer, or film) such that the anode materials 110 and cathode materials 130 are fluidically and/or chemically isolated from each other. This can allow for independent optimization of the properties of each of the electrodes. In some embodiments, the separator 150 can include, or be composed of, polyethylene, polypropylene, high density polyethylene, polyethylene terephthalate, polystyrene, a thermosetting polymer, hard carbon, a thermosetting resin, a polyimide, a ceramic coated separator, an inorganic separator, cellulose, glass fiber, a polyethylenoxide (PEO) polymer in which a lithium salt is complexed to provide lithium conductivity, Nafion™ membranes which are proton conductors, or any other suitable separator material, or combinations thereof. Examples of electrochemical cells that include a separator with a selectively permeable material that can chemically and/or fluidically isolate the anode from the cathode while facilitating ion transfer during charge and discharge of the cell are described in U.S. Patent Publication No. 2019/0348705, entitled, “Electrochemical Cells Including Selectively Permeable Membranes, Systems and Methods of Manufacturing the Same,” filed Jan. 8, 2019, the entire disclosure of which is hereby incorporated by reference.

In some embodiments, the separator 150 can include a conventional separator. For instance, a conventional separator can be any membrane capable of ion transport, i.e., an ion-permeable membrane. In some embodiments, the separator 150 can include a liquid impermeable membrane that permits the transport of ions therethrough, namely a solid or gel ionic conductor. In some embodiments, the separator 150 can be a porous polymer membrane infused with a liquid electrolyte that allows for the shuttling of ions between the cathode and the anode electroactive materials, while preventing the transfer of electrons. In some embodiments, the separator 150 can be a microporous membrane that prevents particles included in the cathode and the anode compositions from crossing the membrane. In some embodiments, the separator can be a single or multilayer microporous separator.

In some embodiments, the separator 150 can be made by coating solid-state electrolyte material onto a separator, e.g., using a vapor deposition process, a cold spray process, a plasma deposition process, electrochemical deposition, and/or a sol-gel process. In some embodiments, the separator 150 can be made by coating solid-state powders with polymer binders onto a separator, e.g., using a liquid coating process or extrusion process with or without a hot/cold press process. In some embodiments, the separator 150 can include a ceramic material.

In some embodiments, the separator 150 can have 0% to about 30% porosity, about 1% to about 29%, about 1% to about 28%, about 1% to about 27%, about 1% to about 26%, about 1% to about 25%, about 1% to about 24%, about 1% to about 23%, about 1% to about 22%, about 1% to about 21%, about 1% to about 20%, or less than about 20% porosity, inclusive of all values and ranges therebetween.

In some embodiments, the separator 150 is larger than the first anode material 110a and/or second anode material 110b. That is, in some embodiments, the separator 150 extends beyond the anode materials 110.

In some embodiments, the anode current collector 120 can include a metal such as copper. In some embodiments, the cathode current collector 140 can include a metal such as aluminum, copper, lithium, nickel, stainless steel, tantalum, titanium, tungsten, vanadium, or a mixture, combinations or alloys thereof. In some embodiments, the anode current collector 120 and/or the cathode current collector 140 can include a non-metal material such as carbon, carbon nanotubes, or a metal oxide (e.g., TiN, TiB₂, MoSi₂, n-BaTiO₃, Ti₂O₃, ReO₃, RuO₂, IrO₂, etc.). In some embodiments, the anode current collector 120 and/or the cathode current collector 140 can include a conductive coating disposed on any of the aforementioned metal and non-metal materials. In some embodiments, the conductive coating can include a carbon-based material, conductive metal and/or non-metal material, including composites or layered materials. In some embodiments, the anode current collector 120 and/or the cathode current collector 140 can include a conductive material in the form of a substrate, sheet, mesh, or foil, or any other form factor.

In some embodiments, the anode current collector 120 may include copper, aluminum, or titanium and the cathode current collector 140 may include aluminum, in the form of sheets or mesh, or any combination thereof. Current collector materials can be selected to be stable at the operating potentials of the positive and negative electrodes of electrochemical apparatus 100. For example, in non-aqueous lithium systems, the cathode current collector 140 can include aluminum, or aluminum coated with conductive material that does not electrochemically dissolve at operating potentials of 2.5-5.0V with respect to Li/Li+. Such materials include platinum, gold, nickel, conductive metal oxides such as vanadium oxide, and carbon. The anode current collector 120 can include copper or other metals that do not form alloys or intermetallic compounds with lithium, carbon, and/or coatings comprising such materials disposed on another conductor.

In some embodiments, the anode current collector 120 and/or the cathode current collector 140 can include a base substrate having one or more surface coatings so as to improve the mechanical, thermal, chemical, or electrical properties of the current collector. In one example, the coating(s) on the current collector can be configured to reduce corrosion and alter adhesion characteristics (e.g., hydrophilic or hydrophobic coatings, respectively). In another example, the coating(s) on the anode current collector 120 and/or the cathode current collector 140 can include a material of high electrical conductivity to improve the overall charge transport of the base substrate. In yet another example, the coatings can include a material of high thermal conductivity to facilitate heat dissipation of the base substrate and protect the battery from overheating. In yet another example, the coatings can include a heat-resistant or fire-retardant material to prevent the battery from fire hazards. In yet another example, the coatings can be configured to be rough so as to increase the surface area and/or the adhesion with the electrode material (e.g., anode materials 110 and cathode materials 130). In yet another example, the coatings can include a material with good adhering or gluing properties with the electrode material.

In some embodiments, the anode current collector 120 and/or the cathode current collector 140 includes a porous current collector such as a wire mesh. The wire mesh (also referred to herein as “mesh”) can include any number of filament wires that can be assembled in various configurations using suitable processes, such as a regular pattern or structure produced by weaving, braiding, knitting, etc. or a more random pattern or structure produced by randomly distributing wires and joining them by welding, adhesives, or other suitable techniques.

In some embodiments, the anode current collector 120 and/or the cathode current collector 140 can be produced via any of the following coating or deposition techniques including, but not limited to, chemical vapor deposition (CVD) (including initiated CVD, hot-wire CVD, plasma enhanced CVD, and other forms of CVD), physical vapor deposition, sputter deposition, magnetron sputtering, radio frequency sputtering, atomic layer deposition, pulsed laser deposition, plating, electroplating, dip-coating, brushing, spray-coating, sol-gel chemistry (through dip-coating, brushing or spray-coating), electrostatic spray coating, 3D printing, spin coating, electrodeposition, powder coating, sintering, self-assembly methods, and any combination of the techniques thereof.

In some embodiments, the electrochemical apparatus 100 can include one or more electrolyte solutions. Electrolyte solutions can include ethylene carbonate (EC), gamma-butyrolactone (GBL), Lithium bis(fluorosulfonyl) imide (LiFSI), trioctyl phosphate (TOP), propylene carbonate (PC), dimethoxyethane (DME), bis(trifluoromethanesulfonyl)imide (TSFI), Li_{1.4}Al_{0.4}Ti_{1.6}(PO₄)₃ (LATP), and any combinations thereof. Additional examples of active materials, conductive materials, and electrolyte solutions that can be incorporated in the electrochemical apparatus 100 are described in U.S. Pat. No. 9,484,569, entitled, “Electrochemical Slurry Compositions and Methods of Preparing the Same,” and in U.S. Pat. No. 9,437,864 entitled, “Asymmetric Battery Having a Semi-Solid Cathode and High Energy Density Anode,” registered Sep. 6, 2016, the entire disclosures of which are hereby incorporated by reference.

In some embodiments, the electrochemical apparatus 100 may further include a pouch film disposed on the cathode current collector 140, the anode current collector 120 not being coupled to a pouch film. In some embodiments, the pouch film can form a portion of a pouch. In some embodiments, the cathode current collector 140 can be deposited on the pouch film via a number of deposition or coating techniques known in the art.

In some embodiments, the electrochemical apparatus 100 can be disposed into a single pouch. In some embodiments, the electrochemical apparatus 100 is completely sealed in the pouch (e.g., via vacuum sealing). In some embodiments, the pouch can be only partially sealed or not sealed at all. In some embodiments, the pouch can be sealed around its perimeter to enclose the electrochemical apparatus 100.

In some embodiments, the pouch can include a three-layer structure, namely an intermediate layer sandwiched by an outer layer and an inner layer, wherein the inner layer is in contact with the cathode current collector 140. For example, the outer layer can include a nylon-based polymer film. The inner layer can include a polypropylene (PP) polymer film, which can be corrosion-resistive to acids or other electrolyte and insoluble in electrolyte solvents. The intermediate layer can include of aluminum (Al) foil. This structure may allow the pouch to have both high mechanical flexibility and strength.

In some embodiments, the outer layer of the pouch may include polymer materials such as polyethylene terephthalate (PET), polybutylene terephthalate (PBT), nylon, high-density polyethylene (HDPE), oriented polypropylene (o-PP), polyvinyl chloride (PVC), polyimide (PI), polysulfone (PSU), and any combinations thereof. In some embodiments, the intermediate layer of the pouch can include metal layers (foils, substrates, films, etc.) comprising aluminum (Al), copper (Cu), stainless steel (SUS), and their alloys or any combinations thereof. In some embodiments, the inner layer of the pouch may include materials such as cast polypropylene (c-PP), polyethylene (PE), ethylene vinylacetate (EVA), PET, Poly-vinyl acetate (PVA), polyamide (PA), acrylic adhesives, ultraviolet (UV)/electron beam (EB)/infrared (IR) curable resin, and any combinations thereof.

In some embodiments, the pouch can include a non-flammable material, such as for example, polyether ether ketone (PEEK), polyethylene naphthalate (PEN), polyethersulfone (PES), PI, polyphenylene sulfide (PPS), polyphenylene oxide (PPO), and any combinations thereof. In some embodiments, the pouch can include a coating or a film of flame retardant additive material, such as flame retardant PET.

In some embodiments, the pouch can include a two-layer structure, namely an outer layer and an inner layer. In some embodiments, the outer layer can include PET, PBT, or other materials as described above. In some embodiments, the inner layer can include PP, PE, or other materials described above. In some embodiments, the inner layer is in contact with the cathode current collector 140.

In some embodiments, the electrochemical apparatus 100 may further include an anode tab (not shown) extending from the anode current collector 120 and a cathode tab (not shown) extending from the cathode current collector 140. In some embodiments, the anode tab extends from the anode current collector 120 in a first direction, and the cathode tab extends from the cathode current collector 140 in a second direction. In some embodiments, the second direction may be similar to (e.g., substantially parallel to), or substantially the same as, the first direction. In some embodiments, the second direction may be different than the first direction. In some embodiments, the second direction may be approximately perpendicular to the first direction. In some embodiments, the second direction may be approximately opposite the first direction.

In some embodiments, the anode tab extends from the anode current collector 120 in a first direction, and the cathode tab extends from the cathode current collector 140 in a second direction, the second direction approximately parallel to the first direction.

In some embodiments, the anode tab and/or the cathode tab can be long enough that if the electrochemical apparatus 100 is placed in a pouch that is sealed, the tab can be exposed outside the pouch and can be used for electrically connecting the battery cell. In some embodiments, the anode tab and/or the cathode tab can be sealed inside the pouch, and in such cases, a hole can be created in the pouch to enable electrical connection between the electrochemical apparatus 100 and an external contact or an electrical circuit. One or more holes can be placed in any location on the pouch.

The electrochemical apparatus 100 can provide several benefits. For example, the folded design approach used in the electrochemical apparatus 100 can be conveniently integrated into manufacturing of any type of batteries including, for example, semi-solid electrodes and conventional solid electrodes, leading to a decrease in the amount of inactive materials (e.g., current collectors, separators, packaging (e.g., pouches), tabs, tape, or electrolytes, and binders (if present)) with respect to the amount of active materials (e.g., anode and cathode materials). In some embodiments, inactive materials of the electrochemical apparatus 100 can make up no more than about 30%, no more than about 29%, no more than about 28%, no more than about 27%, no more than about 26%, no more than about 25%, no more than about 24%, no more than about 23%, no more than about 22%, no more than about 21%, no more than about 20%, no more than about 19%, no more than about 18%, no more than about 17%, no more than about 16%, no more than about 15%, no more than about 14%, no more than about 13%, no more than about 12%, no more than about 11%, or no more than about 10 of the total weight and/or volume of the electrochemical apparatus 100.

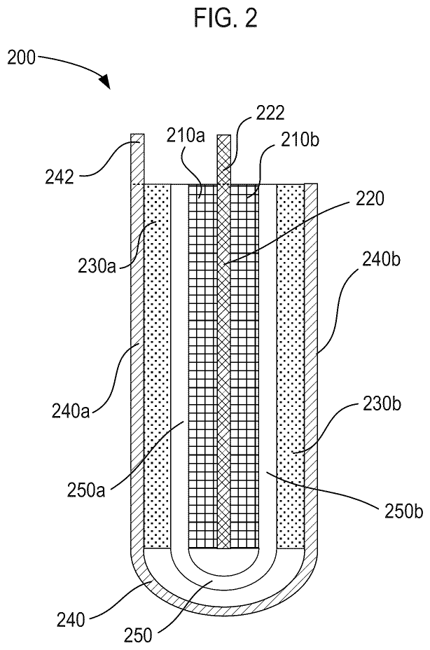

FIG. 2 shows an illustration of an electrochemical apparatus 200 including conductive tabs (222 and 242) to couple the electrochemical apparatus 200 to external circuits, neighboring battery cells, or other electrical components in an application, according to an embodiment. The electrochemical apparatus 200 includes an anode current collector 220, a first anode material 210a disposed on a first side of the anode current collector 220 and a second anode material 210b disposed on a second side of the anode current collector 220, the second side being opposite to the first side. The electrochemical apparatus 200 further includes a cathode current collector 240, a first cathode material 230a disposed on a first section 240a of the cathode current collector 240 and a second cathode material 230b disposed on a second section 240b of the cathode current collector 240. As shown in FIG. 2, in some embodiments, the electrochemical apparatus 200 further includes a separator 250 folded such that a first portion 250a of the separator 250 is interposed between the first anode material 210a and the first cathode material 230a and a second portion 250b of the separator 250 is interposed between the second anode material 210b and the second cathode material 230a.

In some embodiments, the first anode material 210a, the second anode material 210b, the anode current collector 220, the first cathode material 230a, the second cathode material 230b, the cathode current collector 240, and the separator 250 can be similar to, or substantially the same as, (e.g., can have the same or substantially similar properties to) the first anode material 110a, the second anode material 110b, the anode current collector 120, the first cathode material 130a, the second cathode material 130b, the cathode current collector 140, and the separator 150, respectively, as described herein with reference to FIG. 1. Therefore, certain features of the first anode material 210a, the second anode material 210b, the anode current collector 220, the first cathode material 230a, the second cathode material 230b, the cathode current collector 240, and/or the separator 250 are not described in further detail herein.

In some embodiments, the first cathode material 230a and the second cathode material 230b (collectively referred to as “cathode materials 230”) can be arranged on the cathode current collector 240 in a segmented fashion. As illustrated in FIG. 2, in some embodiments, the first cathode material 230a and the second cathode material 230b can form two segments on the cathode current collector 240 with a gap therebetween. In some embodiments, the cathode materials 230, disposed on the cathode current collector 240, can be divided into more than two segments. Alternatively, in other embodiments, the cathode materials 230 may be arranged on the cathode current collector 240 in a continuous manner. That is, there can optionally be no gap between the first cathode material 230a and the second cathode material 230b, resulting in a continuous disposition of the cathode materials 230 on the cathode current collector 240.

In some embodiments, each current collector (i.e., 220 and 240) in the electrochemical apparatus 200 can have a lead portion (or connecting point) that extends out of the anode current collector 220 and/or the cathode current collector 240 (i.e., the electrode tabs 222 and 242 as shown in FIG. 2). In some embodiments, the anode tab 222 can be part of the anode current collector 220. In some embodiments, the cathode tab 242 can be part of the cathode current collector 240. For example, the anode current collector 220 and/or the cathode current collector 240 can have a lead portion extending out of the electrode portion (e.g., electrode tabs 222 and 242 as shown in FIG. 2). In some embodiments, the tab can be a separate element (e.g., a metal strip or wire) that is electrically coupled to the electrode. The coupling can be either to the anode current collector 220/cathode current collector 240, or to the electrode material (i.e., electrode slurry), and can be achieved by welding, gluing, stapling, or other means known in the art.

In some embodiments, as shown in FIG. 2, the electrochemical apparatus 200 includes an anode tab 222 extending from the anode current collector 220 and a cathode tab 242 extending from the cathode current collector 240. In some embodiments, the anode tab 222 and the cathode tab 242 can be on the same side of the electrochemical apparatus 200, as depicted in FIG. 2. In some embodiments, the anode tab 222 and the cathode tab 242 can extend from opposite sides of the electrochemical apparatus 200.

In some embodiments, the electrochemical apparatus 200 can be disposed in a single pouch. In some embodiments, the electrode tabs 222 and 242 can extend out of a pouch (not shown) so as to electrically couple the electrochemical apparatus 200 to external elements, such as other battery cells.

In some embodiments, the anode tab 222 is in electrical communication with each anode of the electrochemical apparatus 200, and the cathode tab 242 is in electrical communication with each cathode of the electrochemical apparatus 200.

In some embodiments, the anode tab 222 and/or the cathode tab 242 can include a metal strip. In some embodiments, the anode tab 222 and/or the cathode tab 242 can be in the form of a wire. In some embodiments, the cathode current collector 240 and/or the anode current collector 220 can be mesh current collectors and the corresponding tabs 242 and/or 222 can be, for example, a metal wire, a bundle of metal wires, a braid of metal wires, or an array of metal wires. In some embodiments, the metal wires can be substantially the same as the wire forming the mesh current collectors. In some embodiments, the metal wires can comprise a different conductive material from the metal material as used in the mesh current collector.

In some embodiments, the anode tab 222 and/or the cathode tab 242 can be composed of aluminum, copper, a conductive ceramic, a conductive polymer, a carbon fiber paper, or any combination thereof.

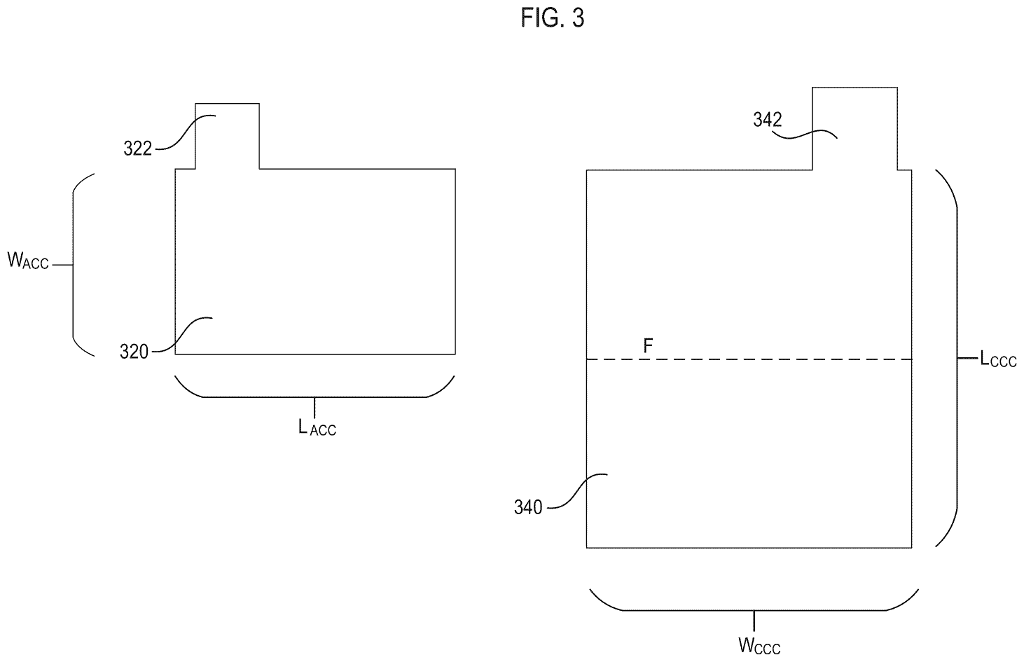

FIG. 3 illustrates one example of relative dimensions of a cathode current collector 340 and an anode current collector 320, and a tabbing arrangement for the cathode current collector 340 and an anode current collector 320 in an electrochemical apparatus. An anode tab 322 extends from the anode current collector 320 and a cathode tab 342 extends from the cathode current collector 340. In some embodiments, the anode tab 322 and the cathode tab 342 can be on the same side of the electrochemical apparatus, as depicted in FIG. 3.

In some embodiments, the anode current collector 320, the cathode current collector 340, the anode tab 322, and the cathode tab 342 can be similar to, or substantially the same as (e.g., have the same or substantially similar properties to) the anode current collector 120, 220, the cathode current collector 140, 240, the anode tab 222, and the cathode tab 242 as described herein with reference to FIG. 1 and FIG. 2. Therefore, certain features of the anode current collector 320, the cathode current collector 340, the anode tab 322, and/or the cathode tab 342 are not described in further detail herein.

In some embodiments, the anode current collector 320 can have a width (referred to as “W_{ACC}” in FIG. 3) of at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 11 cm, at least about 12 cm, at least about 13 cm, at least about 14 cm, or at least about 15 cm. In some embodiments, the anode current collector 320 can have a width W_{ACC} of no more than about 20 cm, no more than about 19 cm, no more than about 18 cm, no more than about 17 cm, no more than about 16 cm, no more than about 15 cm, no more than about 14 cm, no more than about 13 cm, no more than about 12 cm, no more than about 11 cm, or no more than about 10 cm. Combinations of the above-referenced widths are also possible (e.g., at least about 1 cm and no more than about 15 cm or at least about 5 cm and no more than about 20 cm), inclusive of all values and ranges therebetween. In some embodiments, the anode current collector 320 can have a width W_{ACC} of about 1 cm, about 2 cm, about 3 cm, about 4 cm, about 5 cm, about 6 cm, about 7 cm, about 8 cm, about 9 cm, about 10 cm, about 11 cm, about 12 cm, about 13 cm, about 14 cm, about 15 cm, about 16 cm, about 17 cm, about 18 cm, about 19 cm, or about 20 cm.

In some embodiments, the anode current collector 320 can have a length (referred to as “L_{ACC}” in FIG. 3) of at least about 1 cm, at least about 3 cm, at least about 5 cm, at least about 7 cm, at least about 10 cm, at least about 11 cm, at least about 13 cm, at least about 15 cm, at least about 17 cm, at least about 20 cm, at least about 21 cm, at least about 23 cm, at least about 25 cm, at least about 27 cm, at least about 30 cm, at least about 31 cm, at least about 33 cm, at least about 35 cm, at least about 37 cm, or at least about 40 cm. In some embodiments, the anode current collector 320 can have a length L_{ACC} of no more than about 50 cm, no more than about 49 cm, no more than about 47 cm, no more than about 45 cm, no more than about 43 cm, no more than about 40 cm, no more than about 37 cm, no more than about 35 cm, no more than about 33 cm, no more than about 30 cm, no more than about 27 cm, no more than about 25 cm, no more than about 23 cm, no more than about 20 cm, no more than about 17 cm, no more than about 15 cm, no more than about 13 cm, or no more than about 10 cm. Combinations of the above-referenced lengths are also possible (e.g., at least about 5 cm and no more than about 35 cm or at least about 20 cm and no more than about 50 cm), inclusive of all values and ranges therebetween. In some embodiments, the anode current collector 320 can have a length L_{ACC} of about 1 cm, about 3 cm, about 5 cm, about 7 cm, about 10 cm, about 13 cm, about 15 cm, about 17 cm, about 20 cm, about 23 cm, about 25 cm, about 27 cm, about 30 cm, about 33 cm, about 35 cm, about 37 cm, about 40 cm, about 43 cm, about 45 cm, about 47 cm, or about 50 cm.

In some embodiments, the cathode current collector 340 can have a width (referred to as “W_{CCC}” in FIG. 3) of at least about 2 cm, at least about 3 cm, at least about 5 cm, at least about 7 cm, at least about 10 cm, at least about 11 cm, at least about 13 cm, at least about 15 cm, at least about 17 cm, at least about 20 cm, at least about 21 cm, at least about 23 cm, at least about 25 cm, at least about 27 cm, at least about 30 cm, at least about 31 cm, at least about 33 cm, at least about 35 cm, at least about 37 cm, or at least about 40 cm. In some embodiments, the cathode current collector 340 can have a width W_{CCC} of no more than about 50 cm, no more than about 49 cm, no more than about 47 cm, no more than about 45 cm, no more than about 43 cm, no more than about 40 cm, no more than about 37 cm, no more than about 35 cm, no more than about 33 cm, no more than about 30 cm, no more than about 27 cm, no more than about 25 cm, no more than about 23cm, no more than about 20 cm, no more than about 17 cm, no more than about 15 cm, no more than about 13 cm, or no more than about 10 cm. Combinations of the above-referenced widths are also possible (e.g., at least about 5 cm and no more than about 35 cm or at least about 20 cm and no more than about 50 cm), inclusive of all values and ranges therebetween. In some embodiments, the cathode current collector 340 can have a width W_{CCC} of about 2 cm, about 3 cm, about 5 cm, about 7 cm, about 10 cm, about 13 cm, about 15 cm, about 17 cm, about 20 cm, about 23 cm, about 25 cm, about 27 cm, about 30 cm, about 33 cm, about 35 cm, about 37 cm, about 40 cm, about 43 cm, about 45 cm, about 47 cm, or about 50 cm.

In some embodiments, the cathode current collector 340 can have a length (referred to as “L_{CCC}” in FIG. 3) of at least about 2 cm, at least about 3 cm, at least about 5 cm, at least about 7 cm, at least about 10 cm, at least about 11 cm, at least about 13 cm, at least about 15 cm, at least about 17 cm, at least about 20 cm, at least about 21 cm, at least about 23 cm, at least about 25 cm, at least about 27 cm, at least about 30 cm, at least about 31 cm, at least about 33 cm, at least about 35 cm, at least about 37 cm, or at least about 40 cm. In some embodiments, the cathode current collector 340 can have a length L_{CCC} of no more than about 50 cm, no more than about 49 cm, no more than about 47 cm, no more than about 45 cm, no more than about 43 cm, no more than about 40 cm, no more than about 37 cm, no more than about 35 cm, no more than about 33 cm, no more than about 30 cm, no more than about 27 cm, no more than about 25 cm, no more than about 23 cm, no more than about 20 cm, no more than about 17 cm, no more than about 15 cm, no more than about 13 cm, or no more than about 10 cm. Combinations of the above-referenced lengths are also possible (e.g., at least about 5 cm and no more than about 35 cm or at least about 20 cm and no more than about 50 cm), inclusive of all values and ranges therebetween. In some embodiments, the cathode current collector 340 can have a length L_{CCC} of about 2 cm, about 3 cm, about 5 cm, about 7 cm, about 10 cm, about 13 cm, about 15 cm, about 17 cm, about 20 cm, about 23 cm, about 25 cm, about 27 cm, about 30 cm, about 33 cm, about 35 cm, about 37 cm, about 40 cm, about 43 cm, about 45 cm, about 47 cm, or about 50 cm.

As shown in FIG. 3, the cathode current collector 340 can be folded along a fold line F, such that the anode current collector 320 is substantially contained within the cathode current collector 340. In some embodiments, the cathode current collector 340 can have a first surface and a second surface opposite to the first surface, the first surface facing the anode current collector 320 when the cathode current collector 340 is folded along the fold line F. In some embodiments, the second surface of the cathode current collector 340 can be coated with a heat-sealing coating (e.g., a heat-sealable adhesive).

In some embodiments, the cathode current collector 340 has a width W_{CCC} and a length L_{CCC} longer than the width W_{CCC}, and the fold line F can extend along the width W_{CCC}. In some embodiments, the anode current collector 320 has a size (e.g., surface area) approximately half the size of the cathode current collector 340. In some embodiments, a ratio of length L_{CCC} of the cathode current collector 340 to width W_{ACC} of the anode current collector 320 can be in a range of about 1.5 to about 2.5. In some embodiments, the ratio of length L_{CCC} of the cathode current collector 340 to width W_{ACC} of anode current collector 320 may be about 1.5, about 1.6, about 1.7, about 1.8, about 1.9, about 2.0, about 2.1, about 2.2, about 2.3, about 2.4, or about 2.5. In some embodiments, a ratio L_{CCC}:L_{ACC} may be in a range of about 1:1, 1.1:1, 2:1, 1.3:1, 1.4:1, 1.5:1, 1.6:1, 1.7:1, 1.8:1, 1.9:1, 2:1, 2.1:1, 2.2:1, 2.3:1, 2.4:1, 2.5:1, 2.6:1, 2.7:1, 2.8:1, 2.9:1, or 3:1, inclusive. In some embodiments, a ratio W_{CCC}:W_{ACC} may be in a range of about 1:1, 1.1:1, 1.2:1, 1.3:1, 1.4:1, 1.5:1, 1.6:1, 1.7:1, 1.8:1, 1.9:1, or 2:1, inclusive. This design allows for the reduction of the unit cell's footprint, i.e., the space it occupies, without compromising its capacity, thereby enhancing the adaptability of pack form factors.

Alternatively, in some embodiments not depicted in FIG. 3, the central electrode may include a cathode current collector enveloped by an anode current collector, as opposed to the anode current collector being enveloped by the cathode current collector. In such embodiments, a ratio of the anode current collector's length to the cathode current collector's width can be in a range of about 1.5 to about 2.5.

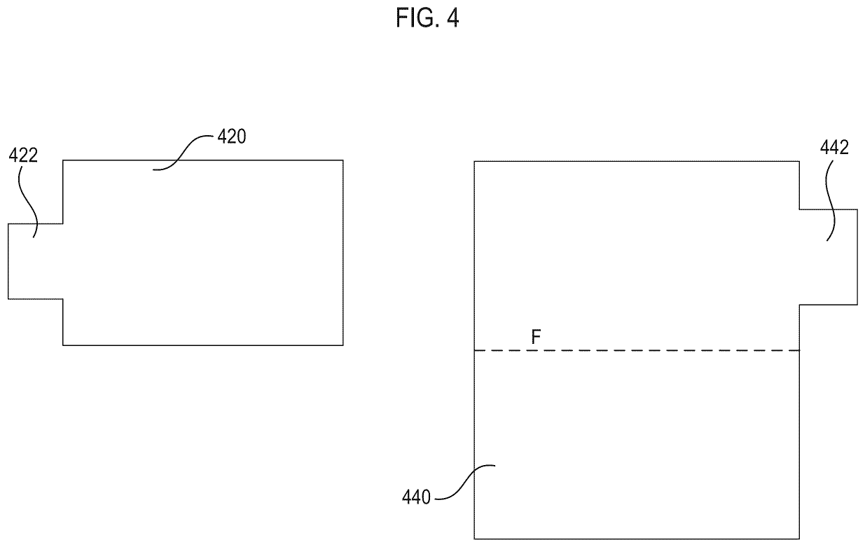

FIG. 4 illustrates one example of relative dimensions of a cathode current collector 440 and an anode current collector 420, and a tabbing arrangement for the cathode current collector 440 and an anode current collector 420 in an electrochemical apparatus. An anode tab 422 extends from the anode current collector 420 and a cathode tab 442 extends from the cathode current collector 440. In some embodiments, the anode tab 422 and the cathode tab 442 can be on the opposite side (i.e., having an angle of about 180 degrees therebetween) of the electrochemical apparatus, as depicted in FIG. 4.

In some embodiments, the anode current collector 420, the cathode current collector 440, the anode tab 422, and the cathode tab 442 can be similar to, or substantially the same as, (e.g., can have the same or substantially similar properties to) the anode current collector 120, 220, 320, the cathode current collector 140, 240, 340, the anode tab 222 322, and the cathode tab 242, 342, respectively, as described herein with reference to FIGS. 1-3. Therefore, certain features of the anode current collector 420, the cathode current collector 440, the anode tab 422, and/or the cathode tab 442 are not described in further detail herein.

As shown in FIG. 4, the cathode current collector 440 can be folded along a fold line F, such that the anode current collector 420 is substantially contained within the cathode current collector 440. In some embodiments, the cathode current collector 440 has a width dimension and a length dimension longer than the width dimension, and the fold line F can extend along the width dimension.

In some embodiments depicted in FIG. 4, the anode current collector 420 can be roughly half the size (e.g., surface area) of the cathode current collector 440, which reduces the amount of inactive material in the electrochemical cell including these current collectors.

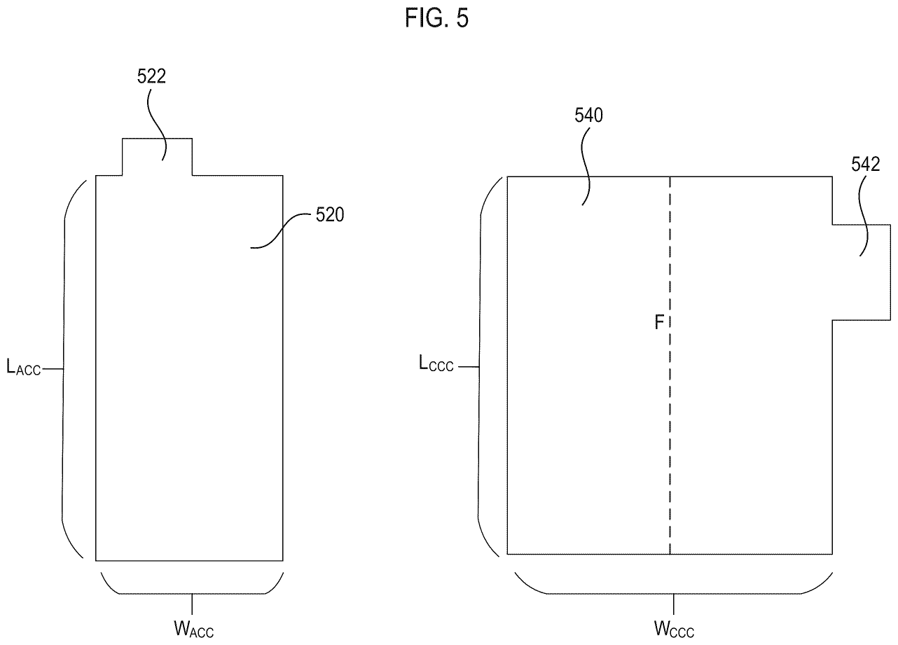

FIG. 5 illustrates one example of relative dimensions of a cathode current collector 540 and an anode current collector 520, and a tabbing arrangement for the cathode current collector 540 and an anode current collector 520 in an electrochemical apparatus. An anode tab 522 extends from the anode current collector 520 and a cathode tab 542 extends from the cathode current collector 540. In some embodiments, the anode tab 522 extends from the anode current collector 520 in a first direction, and the cathode tab 542 extends from the cathode current collector 540 in a second direction, the second direction being approximately perpendicular to the first direction. That is, in some embodiments, the anode tab 522 and the cathode tab 542 can be approximately perpendicular to each other, as depicted in FIG. 4.

In some embodiments, the anode current collector 520, the cathode current collector 540, the anode tab 522, and the cathode tab 542 can be similar to, or substantially the same as, (e.g., can have the same or substantially similar properties to) the anode current collector 120, 220, 320, the cathode current collector 140, 240, 340, the anode tab 222, and the cathode tab 242, respectively, as described herein with reference to FIG. 1, FIG. 2, and/or FIG. 3.

As shown in FIG. 5, the cathode current collector 540 can be folded along a fold line F (e.g., a fold axis), such that the anode current collector 520 can be substantially contained within the cathode current collector 540. In some embodiments, the cathode current collector 540 has a width W_{LCC} and a length L_{CCC} longer than the width W_{LCC}, and the fold line F can extend along the length. In some embodiments, the anode current collector 520 has a width W_{ACC} and a length L_{ACC} longer than the width W_{ACC}. In some embodiments depicted in FIG. 5, the anode current collector 520 has roughly half the size (e.g., surface area) of the cathode current collector 540, which reduces the amount of inactive material. In some embodiments, a ratio of width W_{CCC} of the cathode current collector 540 to width W_{ACC} of the anode current collector 520 is in a range of about 1.5 to about 2.5. In some embodiments, a ratio of width W_{CCC} of the cathode current collector 540 to width W_{ACC} of anode current collector 520 is about 1.5, about 1.6, about 1.7, about 1.8, about 1.9, about 2.0, about 2.1, about 2.2, about 2.3, about 2.4, or about 2.5.

Alternatively, in some embodiments not depicted in FIG. 5, the central electrode may include a cathode current collector enveloped by an anode current collector, as opposed to the anode current collector being enveloped by the cathode current collector. In such embodiments, a ratio of the anode current collector's width to the cathode current collector's width can be in a range of about 1.5 to about 2.5.

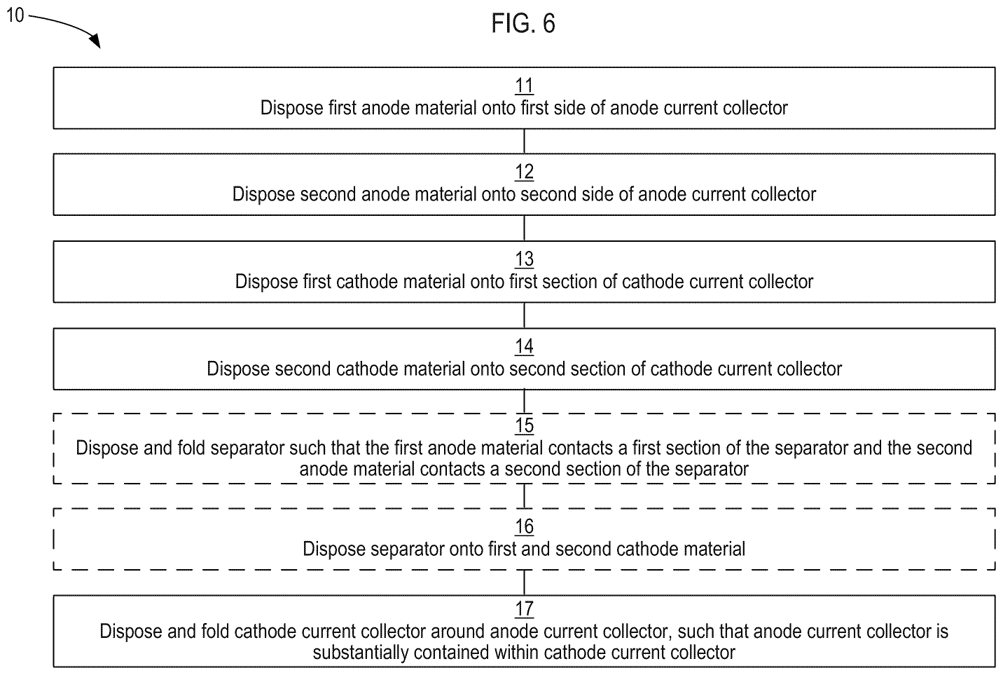

FIG. 6 shows a flow diagram of a method 10 of forming an electrochemical apparatus, according to an embodiment. The method 10 includes disposing a first anode material onto a first side of an anode current collector, at operation 11, disposing a second anode material onto a second side of anode current collector, at operation 12. The method 10 further includes disposing a first cathode material onto a first section of a cathode current collector, at operation 13, and disposing a second cathode material onto a second section of the cathode material, at operation 14. In some embodiments, the method 10 may further include disposing a separator onto either: 1) the first cathode material and the second cathode material; or 2) the first anode material and the second anode material, such that the separator has a folded configuration. In some embodiments, the method 10 may include disposing the separator onto the first anode material and the second anode material, at operation 15, such that the separator has a folded configuration. In some embodiments, the method 10 may include disposing the separator onto the first cathode material and the second cathode material, at operation 16. In some embodiments, the method 10 includes disposing and folding the cathode current collector around the anode current collector such that the anode current collector is substantially contained within the cathode current collector upon folding the cathode current collector around the anode current collector, at operation 17.

In some embodiments, the first anode material, the second anode material, the anode current collector, the first cathode material, the second cathode material, the cathode current collector, and the separator described herein with respect to method 10 can be similar to, or substantially the same as (e.g., have the same or substantially similar properties to) the first anode material 110a, the second anode material 110b, the anode current collector 120, the first cathode material 130a, the second cathode material 130b, the cathode current collector 140, and the separator 150, respectively, as described herein with reference to FIG. 1. Therefore, certain features of the first anode material, the second anode material, the anode current collector, the first cathode material, the second cathode material, the cathode current collector, and/or the separator are not described in further detail herein.

In some embodiments, the method 10 may further include applying an insulating tape to a portion of the cathode current collector, the separator, and the anode current collector to prevent perforation of the separator at the fold area and the resulting electrical contact (i.e., short) between the two electrodes.

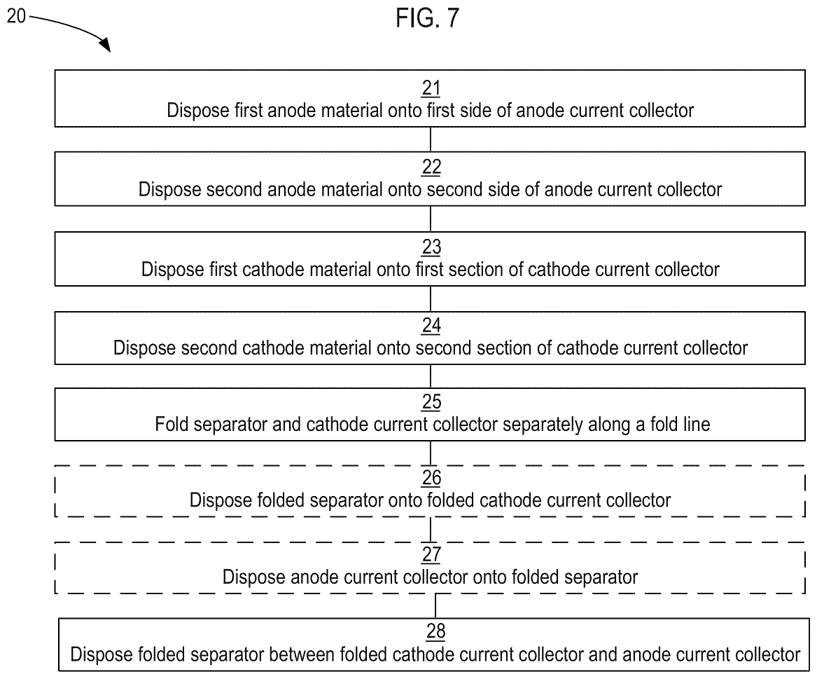

FIG. 7 shows a flow diagram of a method 20 of forming an electrochemical apparatus, according to an embodiment. The method 20 includes disposing a first anode material onto a first side of an anode current collector, at step 21, disposing a second anode material onto second side of anode current collector, at operation 22. The method 20 further includes disposing a first cathode material onto a first section of a cathode current collector, at operation 23, and disposing a second cathode material onto a second section of the cathode material, at operation 24. In some embodiments, the method 20 further includes folding a separator and the cathode current collector separately along a fold line, at operation 25, such that the separator can be substantially contained within the cathode current collector when the separator is disposed on the cathode current collector. That is, the method 20 involves a separate folding process for the separator and the cathode current collector along a designated fold line.

In some embodiments, the method 20 may further include either: 1) disposing the folded separator onto the folded cathode current collector such that the separator can be substantially contained within the cathode current collector; or 2) disposing the anode current collector on the folded separator such that the anode current collector can be substantially contained within the separator.

In some embodiments, the method 20 can include disposing the folded separator onto the folded cathode current collector, at operation 26, such that the separator can be substantially contained within the cathode current collector. In such embodiments, the method 20 may further include disposing the anode current collector on the folded cathode current collector with a folded separator in between the anode current collector and the folded cathode current collector. That is, the method 20 may further include disposing the folded separator between the anode current collector and the folded cathode current collector, at operation 28, to form the electrochemical apparatus.

In some embodiments, the method 20 can include disposing the anode current collector on the folded separator, at operation 27, such that the anode current collector can be substantially contained within the separator. In such embodiments, the method 20 may further include disposing the folded separator onto the folded cathode current collector such that the separator is disposed in between the anode current collector and the folded cathode current collector. That is, the method 20 may further include disposing the folded separator between the anode current collector and the folded cathode current collector, at operation 28, to form the electrochemical apparatus.

In some embodiments, the first anode material, the second anode material, the anode current collector, the first cathode material, the second cathode material, the cathode current collector, and the separator described herein with respect to method 20 can be similar to, or substantially the same as (e.g., have the same or substantially similar properties to) the first anode material 110a, the second anode material 110b, the anode current collector 120, the first cathode material 130a, the second cathode material 130b, the cathode current collector 140, and the separator 150, respectively, as described herein with reference to FIG. 1. Therefore, certain features of the first anode material, the second anode material, the anode current collector, the first cathode material, the second cathode material, the cathode current collector, and/or the separator are not described in further detail herein.

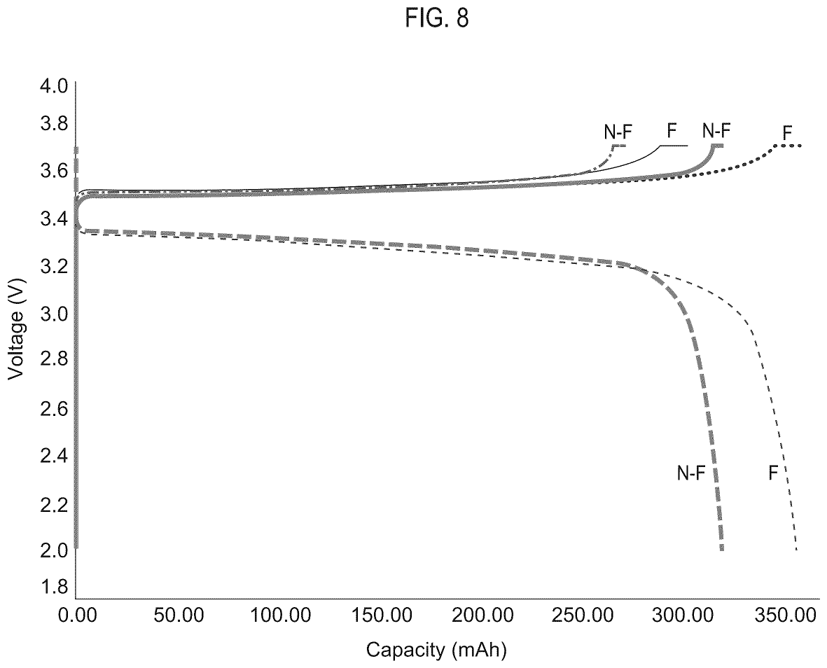

FIG. 8 compares the voltage versus capacity plots of two electrochemical apparatuses. The first, represented as “F” in FIG. 8, is a folded configuration as described in multiple embodiments herein. The electrochemical apparatus of FIG. 8 includes a graphite anode and LFP cathode. The second, denoted as “N-F” in FIG. 8, is a non-folded configuration for comparison. Both configurations are evaluated at a charging C-rate of C/5 and a discharging C-rate of C/3. The electrochemical apparatus' that have a folded configuration according to multiple embodiments described herein demonstrate a higher charge capacity and discharge capacity at both rates (i.e., the C/5 and the C/3-rate) compared to the comparative non-folded electrochemical cell having substantially same chemistry and material properties as to folded-electrochemical cell. While not wishing to be bound by theory, the observed results suggest an increase in the ratio of active to inactive material within the electrochemical apparatus according to various embodiments described herein. An increase in active material can potentially enhance the specific capacity of the battery, given that the active material directly participates in the electrochemical reactions responsible for energy storage and release. Therefore, the embodiments of the present disclosure propose an electrochemical apparatus configuration that is not only cost-effective and easy to manufacture, but also demonstrates superior electrochemical properties.

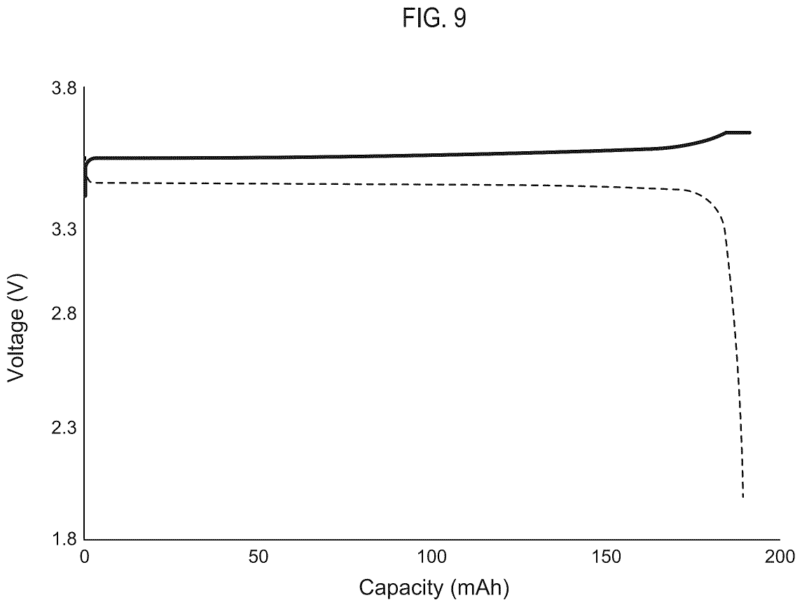

FIG. 9 shows a plot of voltage vs. capacity of an electrochemical apparatus according to an embodiment using conventional electrode, at a charging C-rate of C/20 and a discharging C-rate of C/10. The conventional electrode used herein to obtain the plot of FIG. 9 includes a binder and holds a folded configuration according to multiple embodiments desired herein. The plots observed, which bear resemblance to those in FIG. 8 associated with the folded configuration, indicate that the configuration of the electrochemical apparatus, as described in the present disclosure, can be effectively implemented in traditional electrodes without sacrificing efficiency.

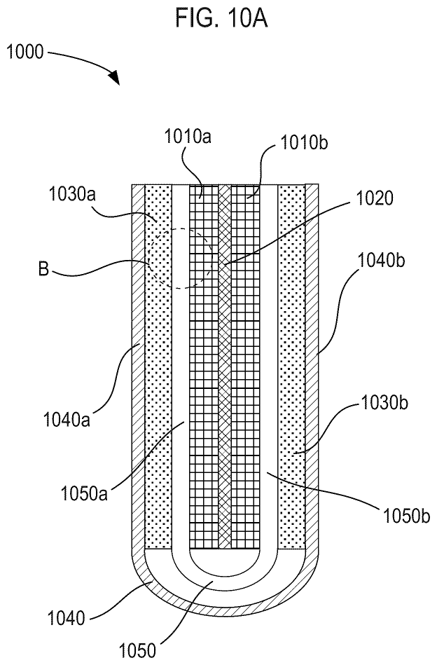

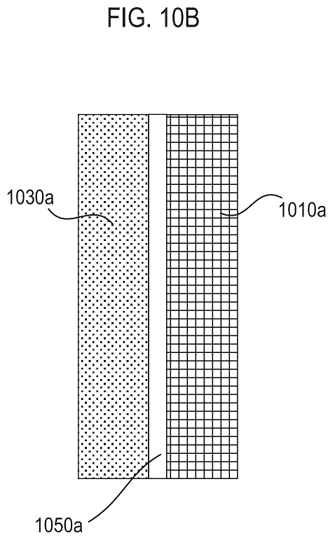

FIGS. 10A-10B show illustrations of an electrochemical apparatus 1000, according to an embodiment. The electrochemical apparatus 1000 includes an anode current collector 1020 having a first side and a second side opposite to the first side, a separator 1050 folded such that the separator 1050 is disposed on both the first side and the second side of the anode current collector 1020, a first anode material 1010a disposed on a first portion 1050a of the separator 1050, a second anode material 1010b disposed on a second portion 1050b of the separator 1050, a first cathode material 1030a disposed on the first portion 1050a of the separator 1050 opposite the first anode material 1030a, a second cathode material 1030b disposed on the second portion 1050b opposite the second anode material 1010b, and a cathode current collector 1040 folded or bent, such that a first portion 1040a of the cathode current collector 1040 is coupled to the first cathode material 1030a and a second portion 1040b of the cathode current collector 1040 is coupled to the second cathode material 1030b. In some embodiments, the anode materials 1010a, 1010b, the anode current collector 1020, the cathode materials 1030a, 1030b, the cathode current collector 1040, and the separator 1050 can be similar to, or substantially the same as, the anode materials 110a, 110b, the anode current collector 120, the cathode materials 130a, 130b, the cathode current collector 140, and the separator 150, respectively, as described herein with reference to FIG. 1. Thus, certain aspects of the anode materials 1010a, 1010b, the anode current collector 1020, the cathode materials 1030a, 1030b, the cathode current collector 1040, and the separator 1050 are not described in greater detail herein. FIG. 10B shows a close-up view of a portion of the electrochemical apparatus 1000 indicated by the line B, as shown in FIG. 10A, detailing interaction between the first anode material 1010a, the first cathode material 1030a, and the first portion 1050a of the separator 1050.

In some embodiments, the design of apparatus 1000 can be modified such that the positions of the anode and cathode can be interchanged. Specifically, the anode current collectors and anode material could replace the cathode current collectors and cathode material. Consequently, it can be possible for the anode current collector to adopt a folded design.

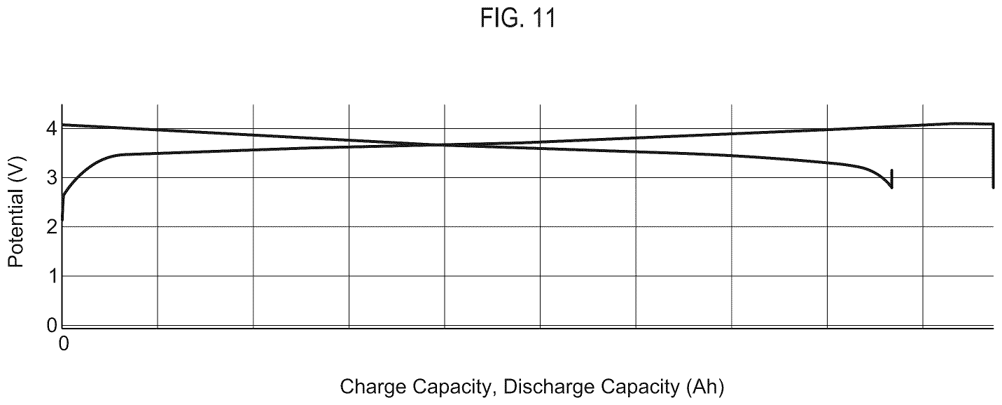

FIG. 11 shows a plot of voltage vs. capacity of an example electrochemical apparatus including NMC cathodes and graphite anodes with a folded separator and folded cathode current collector as shown in FIG. 2 at a charging C-rate of C/20 and a discharging C-rate of C/10. The plots observed, which bear resemblance to those in FIG. 8 and FIG. 9, indicate that the configuration of the electrochemical apparatus which reduces the inactive material in the electrochemical apparatus, as described herein, can be effectively implemented in a variety of electrodes (e.g., semi-solid electrodes) without sacrificing efficiency.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An apparatus, comprising:
an anode current collector;
a first anode material disposed on a first side of the anode current collector;
a second anode material disposed on a second side of the anode current collector, the second side opposite the first side;
a cathode current collector;
a first cathode material disposed on a first section of the cathode current collector;
a second cathode material disposed on a second section of the cathode current collector; and
a separator folded such that a first portion of the separator is interposed between the first anode material and the first cathode material, and a second portion of the separator is interposed between the second anode material and the second cathode material.

2. The apparatus of claim 1, further comprising:
an anode tab extending from the anode current collector; and
a cathode tab extending from the cathode current collector.

3. The apparatus of claim 2, wherein the cathode current collector is folded along a fold line, such that the anode current collector is substantially contained within the cathode current collector.

4. The apparatus of claim 3, wherein the cathode current collector has a width dimension and a length dimension longer than the width dimension, and the fold line extends along the length dimension.

5. The apparatus of claim 3, wherein the cathode current collector has a width dimension and a length dimension longer than the width dimension, and the fold line extends along the width dimension.

6. The apparatus of claim 3, wherein the anode tab extends from the anode current collector in a first direction, and the cathode tab extends from the cathode current collector in a second direction, the second direction approximately perpendicular to the first direction.

7. The apparatus of claim 3, wherein the anode tab extends from the anode current collector in a first direction, and the cathode tab extends from the cathode current collector in a second direction, the second direction approximately parallel to the first direction.

8. The apparatus of claim 1, further comprising a pouch film coupled to the cathode current collector, wherein the anode current collector is not coupled to a pouch film.

9. An apparatus, comprising:
a cathode current collector;
a first cathode material disposed on a first side of the cathode current collector;
a second cathode material disposed on a second side of the cathode current collector, the second side opposite the first side;
an anode current collector;
a first anode material disposed on a first section of the anode current collector;
a second anode material disposed on a second section of the anode current collector; and
a separator folded such that a first portion of the separator is interposed between the first cathode material and the first anode material, and a second portion of the separator is interposed between the second cathode material and the second anode material.

10. The apparatus of claim 9, further comprising:
an anode tab extending from the anode current collector; and
a cathode tab extending from the cathode current collector.

11. The apparatus of claim 10, wherein the anode current collector is folded along a fold line, such that the cathode current collector is substantially contained within the anode current collector.

12. The apparatus of claim 11, wherein the anode current collector has a width dimension and a length dimension longer than the width dimension, and the fold line extends along the length dimension.

13. The apparatus of claim 11, wherein the anode current collector has a width dimension and a length dimension longer than the width dimension, and the fold line extends along the width dimension.

14. The apparatus of claim 11, wherein the anode tab extends from the anode current collector in a first direction, and the cathode tab extends from the cathode current collector in a second direction, the second direction approximately perpendicular to the first direction.

15. The apparatus of claim 11, wherein the anode tab extends from the anode current collector in a first direction, and the cathode tab extends from the cathode current collector in a second direction, the second direction approximately parallel to the first direction.

16. A method of forming an electrochemical apparatus, comprising:
disposing a first anode material onto a first side of an anode current collector;
disposing a second anode material onto a second side of the anode current collector;
disposing a first cathode material onto a first section of a cathode current collector;
disposing a second cathode material onto a second section of the cathode current collector;
disposing a separator onto one of the first cathode material and the second cathode material, or the first anode material and the second anode material, such that the separator has a folded configuration; and
disposing the cathode current collector around the anode current collector by folding the cathode current collector.

17. The method of claim 16, wherein the method comprises:
disposing the separator onto the first cathode material and the second cathode material.

18. The method of claim 16, wherein the method comprises:
disposing the separator onto the first anode material and the second anode material, such that the separator has a folded configuration.

19. The method of claim 16, wherein the anode current collector is substantially contained within the cathode current collector upon folding the cathode current collector around the anode current collector.

20. An apparatus, comprising:
a first anode current collector having a first side and a second side opposite the first side;
a first anode material disposed on the first side of the first anode current collector;
a second anode current collector having a first side and a second side opposite the first side;
a second anode material disposed on the second side of the second anode current collector;
a cathode current collector;
a first cathode material disposed on a first section of the cathode current collector;
a second cathode material disposed on a second section of the cathode current collector; and
a separator folded such that a first portion of the separator is interposed between the first anode material and the first cathode material and a second portion of the separator is interposed between the second anode material and the second cathode material, the second side of the first anode current collector being electrically coupled to the first side of the second anode current collector.

21. The apparatus of claim 20, wherein the cathode current collector is folded along a fold line, such that the first anode current collector and the second anode current collector are substantially contained within the cathode current collector.

22. The apparatus of claim 20, further comprising:
a first anode tab extending from the first anode current collector;
a second anode tab extending from the second anode current collector; and
a cathode tab extending from the cathode current collector, the first anode current collector and the second anode current collector electrically coupled via coupling the first anode tab and the second anode tab.

23. The apparatus of claim 20, wherein the first anode current collector and the second anode current collector are electrically coupled by direct contact under a compressive force.

24. The apparatus of claim 20, wherein the cathode current collector has a width dimension and a length dimension longer than the width dimension, and a fold line extends along the length dimension.

25. The apparatus of claim 20, wherein the cathode current collector has a width dimension and a length dimension longer than the width dimension, and a fold line extends along the width dimension.

26. The apparatus of claim 20, further comprising:
a pouch film coupled to the cathode current collector, wherein the first anode current collector and the second anode current collector are not coupled to the pouch film.

27. An apparatus, comprising:
an anode current collector;
a separator folded such that a first portion of the separator is on a first side of the anode current collector and a second portion of the separator is on a second side of the anode current collector;
a first anode material disposed on the first portion of the separator and adjacent to the anode current collector;
a second anode material disposed on the second portion of the separator and adjacent to the anode current collector;
a cathode current collector;
a first cathode material disposed on the first portion of the separator and adjacent to a first section of the cathode current collector; and
a second cathode material disposed on the second portion of the separator and adjacent to a second section of the cathode current collector.

28. The apparatus of claim 27, further comprising:
an anode tab extending from the anode current collector; and
a cathode tab extending from the cathode current collector.

29. The apparatus of claim 28, wherein the cathode current collector is folded along a fold line, such that the anode current collector is substantially contained within the cathode current collector.

30. The apparatus of claim 29, wherein the cathode current collector has a width dimension and a length dimension longer than the width dimension, and the fold line extends along the length dimension.

31. The apparatus of claim 29, wherein the cathode current collector has a width dimension and a length dimension longer than the width dimension, and the fold line extends along the width dimension.

32. The apparatus of claim 29, wherein the anode tab extends from the anode current collector in a first direction, and the cathode tab extends from the cathode current collector in a second direction, the second direction approximately perpendicular to the first direction.

33. The apparatus of claim 29, wherein the anode tab extends from the anode current collector in a first direction, and the cathode tab extends from the cathode current collector in a second direction, the second direction approximately parallel to the first direction.

34. The apparatus of claim 27, further comprising:
a pouch film coupled to the cathode current collector,
wherein the anode current collector is not coupled to a pouch film.
